(19) United States
(12) Patent Application Publication
(10) Pub. No.: US 2025/0038962 A1
(43) Pub. Date: Jan. 30, 2025

(54) CRYPTOGRAPHIC DEVICES AND SYSTEMS

(71) Applicant: Hewlett-Packard Development Company, L.P., Spring, TX (US)

(72) Inventors: Thalia May Laing, Bristol (GB); Maugan Cedric Villatel, Bristol (GB)

(73) Assignee: Hewlett-Packard Development Company, L.P., Spring, TX (US)

(21) Appl. No.: 18/716,456

(22) PCT Filed: Dec. 17, 2021
(86) PCT No.: PCT/US2021/064112

§ 371 Date: Jun. 4, 2024

(51) Int. Cl. H04L 9/08; H04L 9/32

(52) U.S. Cl. CPC H04L 9/0825; H04L 9/3255

(57) ABSTRACT

Examples relate to machine readable storage storing instructions arranged, when processed, to realise a cryptographic machine readable instructions for signing a message; the instructions comprising: instructions to receive, from a plurality of participating devices of a set of devices, a threshold number of shares of a private key, sk; the shares having been created using a (t,n)-threshold secret sharing scheme, where n>=t and t>n/2; instructions to receive respective state indicia from the plurality of participating devices; the respective state indicia being indicative of the number of messages having been signed using the private key, sk; instructions to recover the private key, sk, using the received shares; instructions to sign a message using a hash-based signature scheme subject to assessing a state indicium indicating the highest number of messages that have been signed using the private key. sk; and instructions to establish a state indicium indicating the highest number of messages, m, that have been signed using the private key, sk.

### BACKGROUND

A stateful hash-based signature scheme (HBSS) is a quantum secure signature scheme that provides integrity and data origin authentication on a message even if an attacker has a quantum computer. It is a digital signature scheme that uses a public-private key pair in which the key pair can be used to sign only a fixed number of messages where the upper bound is defined prior to key generation and requires the signer to maintain a state. Some standards relating to HBSSs neither allow the private key to exist in more than one location at a time nor allow a state to be repeated.

### BRIEF INTRODUCTION OF THE DRAWINGS

Examples will be described with reference to the accompanying drawings in which

FIG. 1 shows an example cryptographic system;

FIG. 2 illustrates a hardware security module;

FIG. 3 depicts a dealer;

FIG. 4 illustrates a flowchart for share generation and distribution;

FIG. 5 shows a flowchart for signing a message;

FIG. 6 depicts a flowchart of hardware security module operations; and

FIG. 7 illustrates machine readable storage storing machine readable instructions.

### DETAILED DESCRIPTION

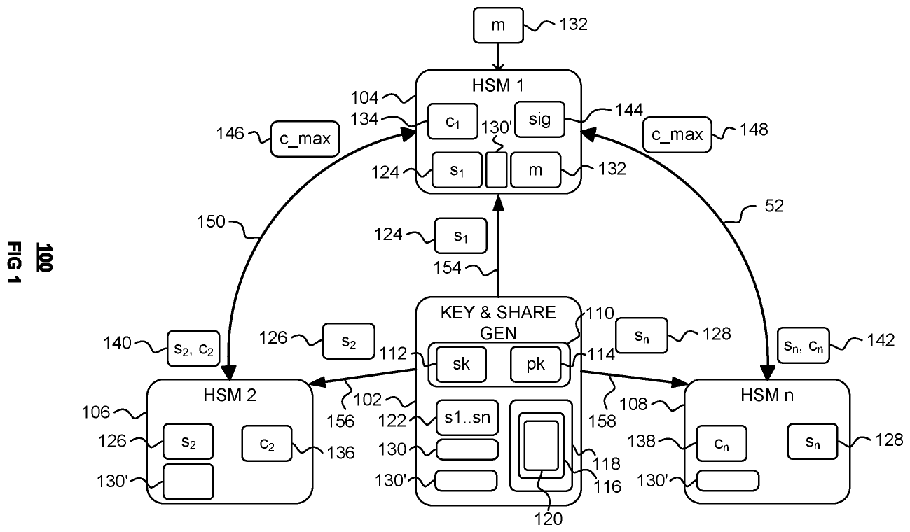

FIG. 1 illustrates a schematic view of an example cryptographic system 100. The cryptographic system 100 comprises a dealer 102 and a number of hardware security modules (HSMs). In the example shown, there are three HSMs 104 to 108. Examples are not limited to three HSMs. Examples can be realised in which two or more HSMs are used. An HSM is an example of a device of a set of devices and the two or more such HSMs is an example of a set of devices.

The dealer 102 is arranged to generate a key pair 110 comprising a private key (sk) 112 and a public key (pk) 114. At least the private key 112 is generated using a hash-based signature scheme parameter set 116 associated with a hash-based signature scheme 118. The hash-based signature scheme parameter set 116 comprises a parameter 120, h, associated with the height of a tree (not shown) associated with the hash-based signature scheme 118. The private key 112 can be one of a set of private keys. The private key or each key of such a set of private keys can be one-time signature private keys. The private key or private keys can be associated with the tree associated with the hash-based signature scheme 118.

The dealer 102 is arranged to generate a number, n, that is, a set, of shares s1 to sn 122 of the private key 112 using a secret sharing scheme such as, for example, a (t,n) threshold secret sharing scheme in which a threshold of t of n shares are required to recover the private key. Any and all examples can be realised in which t>n/2. In the example shown, the set of shares s1 to sn 122 comprises three shares; namely, s1 124, s2 126 and s3 128. Examples can be realised in which n is not limited to three shares. Examples can be realised in which n≥2.

Although the above examples have been described with reference to a dealer generating and distributing shares of the private key 112, examples are not limited to such arrangement. Examples can be realised in which the HSMs 104 to 108 generate the shares of the private key 112 in a distributed manner by cooperating with one another, that is, without a dealer.

The dealer 102 can also be arranged to generate and distribute state information 130 to the HSMs 104 to 108 together with a signing upper bound 130′ indicating the maximum number of times 134 messages can be signed using the private key 112. However, any and all examples can alternatively be realised in which the signing upper bound 130′ is inherent in or derivable from a hash-based signature scheme private key or other generated data and/or parameters. The state information 130 indicates the highest number of times the private key 112 has been used to sign a message 132. Initially, the state information will be set to zero. The state information is an example of a state indicium. The signing upper bound 130′ can be any number such as, for example, 1, which would realise a one-time signature scheme, or more than one, which would realise a multi-time signature scheme.

Each of the HSMs 104 to 108 receives and stores at least a respective share of the number of shares 122 and also receives the state information 130. One or more HSMs 104 to 108 can receive multiple respective shares to confer respective degrees of signing authority according to the number of shares held by an HSM. Also, each HSM receives and stores the signing upper bound 130′ indicating the maximum number of times the private key 112 can be used to sign messages.

Although the HSMs described herein receive the state information 130 from the dealer 102, examples are not limited to such an arrangement. Examples can be realised in which the HSMs 104 to 108 establish respective state information 130 independently of a dealer. The HSMs 104 to 108 establishing respective state information 130 independently of a dealer can be responsive to an event. Examples can be realised in which the event is receiving one or more than one new share.

Each HSM 104 to 108 comprises a respective counter 134 to 138. The counters are used to hold the state information to maintain a record or otherwise keep track of how many times the private key 112 has been used to sign messages. The counters can be initialised to zero at initialisation or provisioning of the system 100. Initialising the counters to zero can be in response to receiving the state information 130 from the dealer 102. Alternatively, the counters can be initialised to zero in response to some other event. Any number, or all, of the counters can be initialised to zero in response to the event of receiving at least one respective share of the secret 112. Each time an HSM 104 to 108 prepares to use, or uses, the private key 112 to sign a message, a respective counter 134 to 138 is incremented. Using the private key 112 to sign a message is subject to the signing upper bound 130′ not being exceeded.

At least a subset of the HSMs 104 to 108 cooperate in sharing respective shares of the private key 112 to allow an HSM holding sufficient shares to recover the private key 112 to sign a message; such an HSM is known as a signing HSM. The minimum size of such a subset is governed by the threshold of the secret sharing scheme. The subset of HSMs 104 to 108 cooperate to ensure that a signing HSM has, or has access to, the highest counter value or state information indicative of the number of times the private key 112 has been used to sign messages thus far. Examples can be realised in which all HSMs are kept apprised of the highest counter value or state information. To ensure that the signing HSM, that is, the HSM charged with signing a message, has access to the most recent state information, that is, the highest current counter value, at least the threshold number, t, of participating HSMs, determined from or governed by the threshold, t, of the secret sharing scheme, send respective state information to the signing HSM. Therefore, examples can be realised in which the at least threshold number, t, of participating HSM is t>n/2. Arranging for the state information to be received from the threshold number, t, of devices ensures that at least one of those devices has participated in the immediately preceding signing and, therefore, will have the most recent version of the state information.

Therefore, assuming that HSM 104 is the signing HSM, the other HSMs 106 and 108 send respective messages 140 and 142 comprising respective share and state information to the signing HSM 104. Although the example depicted indicates that the signing HSM is HSM 104, examples are not limited thereto. Examples can be realised in which any HSM can be charged with signing a message and that the HSM charged with signing a message can vary. Sending the respective messages 140 and 142 can be in response to a triggering event. Examples can be realised in which the triggering event can be a request from the signing HSM for the share and state information. The signing HSM can request the share and state information in response to receiving a message to sign. The triggering event can be raised or generated by any entity of the system 100 or by some entity external to, but in communication with, the system 100.

The signing HSM 104 comprises at least one respective share 124, a respective counter 134 storing respective state information indicating at least the number of times the at least one respective share 124 has been contributed, or otherwise used or made available, for a potential signing or indicating the number of times the private key 112 has been used, or otherwise made available, to sign a message from the perspective of that HSM 104, an indication of the signing upper bound 130′, the message 132 to be signed, and the signature 144 generated using the message 132, the private key 112 and the state information 134.

The other HSMs 106 and 108 comprise at least (a) respective shares 126 and 128, (b) respective counters 136 and 138 storing respective indications of how many times the private key 112 has been used, or otherwise made available, to sign messages and (c) respective copies of the signing upper bound 130′. Any and all examples can be realised in which non-signing participating HSMs would receive a request from the signing HSM 102 to send their shares to the signing HSM, and then increment their state information before sending to the signing HSM 102 a respective share together with the previous state information as it was immediately prior to the state information being incremented. Although the examples described herein refer to state information, examples can be realised in which the state information can be represented using a counter such as, for example, counters 134 to 138. Consequently, examples will be described that use state information and counter synonymously unless the context specifically indicates otherwise.

Incrementing the state information prior to sending a respective share protects against an HSM contributing a share but then having a failure before incrementing the state information, which would then risk disastrous state information or counter re-use.

In response to signing a message, the signing HSM 104 and the other HSMs can update their respective state information indicating the highest number of times the private key 112 has been used to sign a message. Following signing the message 132, the signing HSM 104 is arranged to send communications 146 and 148 to the other HSM 106 and 108 to cause the other HSMs 106 to 108 to establish or otherwise update respective state information, stored in counters 136 and 138, indicating the highest number of times that the private key 112 has been used to sign a message.

The HSMs and dealer communicate using respective secure channels 150 to 158.

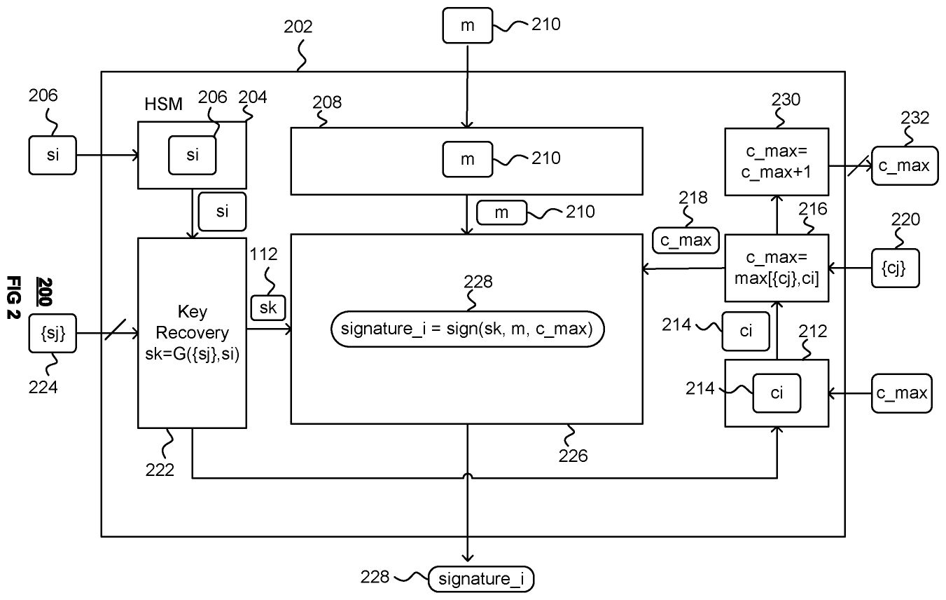

Referring to FIG. 2, there is shown a view 200 of an HSM 202. The HSM 200 is an example of each of the above HSMs 104 to 108. The HSM 200 comprises memory 204 for receiving and storing at least one share 206 of the private key 112, memory 208 for receiving and storing a message 210, and memory 212 to store state information 214 indicating the current highest number of times the private key 112 has been used to sign a message. The state information 214 can be a count maintained and incremented by the HSM 202. Alternatively, or additionally, the indication 214 can be received from another HSM or other entity following that other HSM or other entity performing, or being aware of, or contributing a respective share to, signing a message using the private key 112. Furthermore, even though the example HSM 202 has been described as comprising memory 208 for receiving and storing a message 210 to be signed, not every HSM has to have such a memory 208. HSMs can be realised that perform the role of signing HSMs would have such a memory 208. However, HSMs that do not perform the role of a signing HSM do not need to have such a memory 208.

The at least one share 206 is an example of any of the above-described shares 124 to 128. The message 210 is an example of the above-described message 132. The state information 214 is an example of the above-described state information 134 to 138.

Although examples have been described with reference to HSMs being configured as indicated in and/or described with reference to FIG. 2, examples are not limited to such arrangements. Examples can be realised in which the HSMs have different levels of functionality. The different levels of functionality can follow from the HSM having different levels of resources such as, for example, at least one, or both, of available memory and processing power. For example, a subset of HSMs of the total set of HSMs may have the capability of signing a message while the remaining HSM in the total set of HSMs may not have the capability of signing a message because signing a message uses significant computing resources like memory and processor power.

The HSM 200 comprises logic 216 to determine state information 218 indicating the current highest number of times that the private key 112 has been used to sign a message. The logic 216 is arranged to receive a number or set 220 of respective current highest indications of the number of times the private key 112 has been used to sign messages; the number or set 220 of respective current highest indications is associated with a threshold number, t, of other HSMs. The number or set 220 of respective current highest indications of the number of times the private key 112 has been used to sign messages is an indication of a set of state indicia. The threshold number of other HSMs is t>n/2, which is governed by the (t,n) threshold secret sharing scheme in which n is the total number of HSMs in a system. Examples can be realised in which determining the state information indicating the highest number of times the private key 112 has been used to sign a message comprises selecting the highest value from the set of possible values comprising the received highest values 220 and a locally stored highest value 214. For example, assuming that HSM 202 is a signing HSM that is also a participating HSM, the signing HSM will need access to a total of at least t shares, at least a subset of that total of t shares will be provided by non-signing HSMs and the balance of the total of t shares will be provided by the signing, participating, HSM. A participating HSM is an HSM that contributes at least one respective share to signing. However, a signing HSM that is not also a participating HSM will receive all shares needed to sign a message from participating HSMs. Therefore, for example, assuming each HSM has a single respective share, and that a signing HSM is also a participating HSM, the signing HSM will receive at least (t−1) shares from (t−1) other HSMs. However, if the signing HSM is not a participating HSM, the signing HSM will receive at least t shares from t other HSMs. Examples can be realised in which the HSMs can hold one or more than one share, in which case the set of participating HSMs can comprise fewer than (t−1) or fewer than t participating HSMs.

The HSM 202 comprises key recovery logic 222 for recovering the private key 112 from the threshold number, t, of shares of the private key 112. The key recovery logic 222 is arranged to receive a set of shares 224 from other HSMs (not shown) to allow recovery of the private key 112. Recovering the private key 112 can also involve using the received shares 224 and the at least one share 206 held by the HSM 202 to achieve the threshold number, t, of shares needed used to recover the private key 112. Alternatively, or additionally, if the key recovery is performed by an entity that does not have a respective share, the received set of shares 224 will comprise at least the threshold number, t, of shares needed to recover the private key 112.

The HSM 202 comprises signature logic 226 for generating a signature 228 associated with the message 210. The signature 228 is derived from the private key 112, the message 210 and the state information 218, subject or according to the state information 218 being less than the signing upper bound 130′. Generating the signature 228 is subject to the signature logic 226 or other logic determining that the current indication 218 of the highest number of times that the private key 112 has been used to sign a message has not exceeded the signing upper bound 130′. If signing the message 210 using the recovered private key 112 would exceed the signing upper bound 130′ imposed on the number of times that the private key 112 can be used, signing the message 210 is prevented.

The HSM 202 comprises increment or update logic 230 to increment by one, or update, the state information 218 indicating 218 of the highest number of times that the private key 112 has been used to sign a message to form the new state information 232 indicating 232 of the highest number of times the private key 112 has been used to sign a message. Assuming signing the message was successful, the new state information 232 is calculated and output for sending to all other HSMs. Establishing the new state information 232 indicating the highest number of times that the private key 112 has been used to sign a message can be responsive to an event. Examples can be realised in which the event comprises at least one or more of (a) sending, or preparing to send, at least one respective share for use in signing, (b) receiving proof that the private key 112 has been used for signing, (c) receiving an instruction to increment or otherwise update the state information, (d) receiving an update of the new state information that is used to replace the current state information 218 or (e) signing a message using the private key 112.

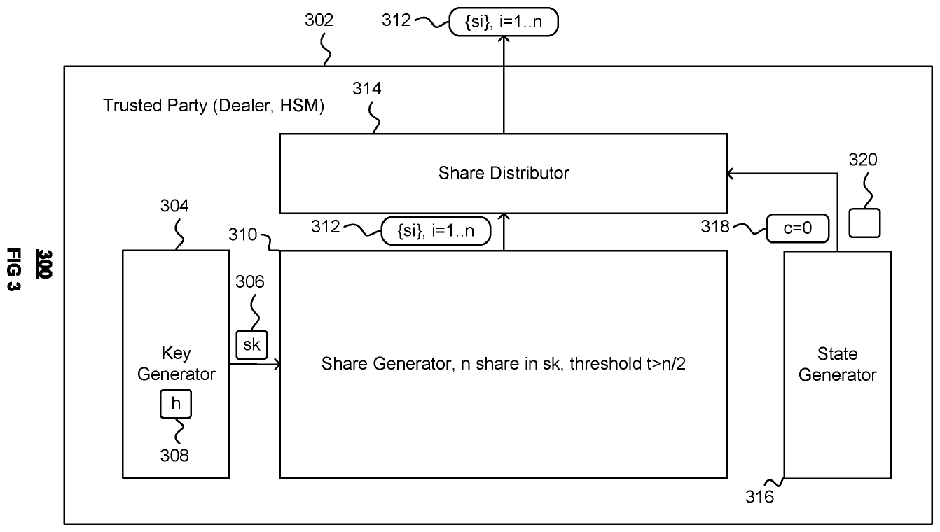

Referring to FIG. 3, there is depicted a view 300 of a dealer 302. The dealer 302 is an example of the above-described dealer 102.

The dealer 302 comprises key generator logic 304 to generate a private key 306. The private key 306 is an example of the above-described private key 112. The key generator logic is response to a set of parameters 308. The set of parameters 308 can be associated with a respective signature scheme. The respective signature scheme can comprise, or be, a hash-based signature scheme. The set of parameters 308 can comprise an indication of the height of the tree (not shown) associated with the HBSS. The set of parameters 308 is an example of the above-described parameter set 116.

The dealer 302 comprises share generator logic 310 to generate shares 312 of the private key 306. The shares 312 can be generated using a secret sharing scheme such as, for example, the above described (t,n) threshold scheme in which n shares are generated and at least t shares are needed to recover the private key, t>n/2. The shares 312 are examples of the above-described shares 122.

The dealer 302 comprises share distributor logic 314. The share distributor logic 314 distributes the shares to respective HSMs.

Examples can be realised in which the dealer 302 additionally comprises state information generator logic 316 for generating state information 318. The state information 318 is an indication of the above-described state information 130.

Examples can be realised in which the state information generator logic 316 can also generate a signing upper bound 320 governing the maximum number of times the private key 306 can be used to sign a message. The signing upper bound 320 is an example of the above-described signing upper bound 130′. The signing upper bound 320 is distributed to all HSMs by the share distributor logic 314.

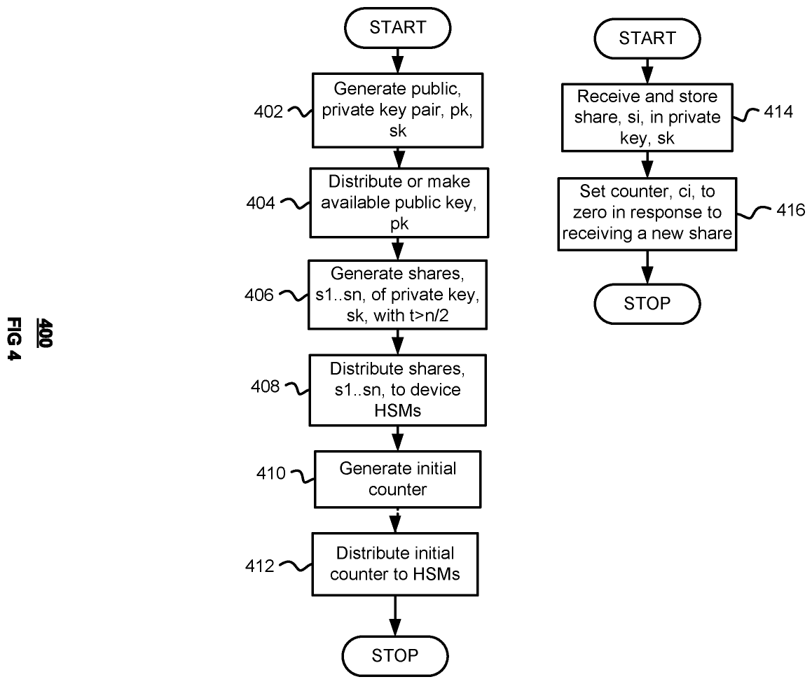

Referring to FIG. 4, there is shown a pair of flowcharts 400 of operations to initialise the system 100. At 402, the dealer 102/302 generates the key pair 110 comprising the private key 112 and the public key 114. The dealer 102/302 distributes the public key at 404. At 406, the dealer 102/302 generates the shares of the private key and, at 408, distributes the shares 122 to the HSMs.

Examples can be realised in which the dealer 102/302 also generates the initial counter or state information at 410 and distributes that initial counter or state information to the HSM at 412, unless the HSMs are arranged to generate respective state information such as, for example, in response to receiving respective shares of the private key 112.

At 414, the HSMs receive and store respective shares of the private key 112. At 416, the HSMs either receive and store the state information or generate respective initial state information if the dealer 102/302 does not generate and distribute that initial state information.

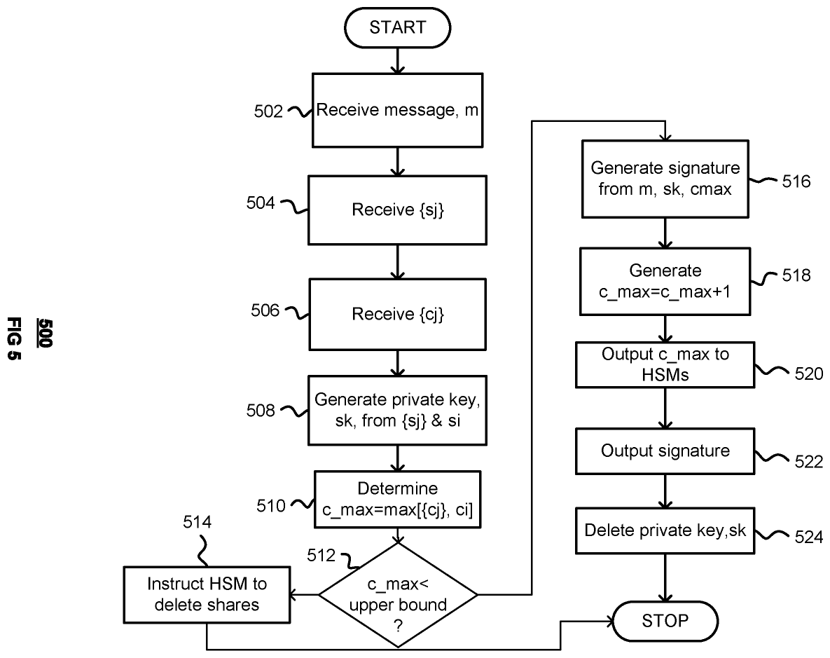

Referring to FIG. 5, there is shown a flowchart 500 for signing a message. The message can be any message described herein.

At 502, the signing HSM 104 receives the message 132 to be signed. At 504, the signing HSM receives the shares 126/128 of the private key 112 from at least a sufficient number of other participating HSMs 106/108 to ensure that the signing HSM 104 has the predetermined threshold, t, of shares to recover the private key 112. At 506, the signing HSM 104 receives the state information or counter values 136/138 associated with the highest number of messages that have been signed using the private key 112 from at least the threshold number of HSMs to ensure that at least one of that threshold number of HSMs has access to the latest state information. An HSM of that at least that threshold number of HSMs will have access to the latest state information if it has been involved in the most recent signing.

At 508, the signing HSM 104 recovers the private key 112 using at least the shares 126/128 received and, if applicable, the respective share 124 issued to the signing HSM 104. If the signing entity was not issued with a respective share 124, the signing entity would need to receive the threshold number, t, of shares from participating HSMs 104 to 108.

At 510, the signing HSM 104 determines the highest state information or counter value, c_max, 218 from at least the received state information 136/138 or 220 and, if applicable, respective stored state information 214. A determination is made, at 512, whether or not the highest state information or counter value 218 is greater than the signing upper bound 130′. If the highest state information or counter value 218 is greater than the signing upper bound 130′, at least all HSMs that participated, or all HSMs, can be instructed, at 514, to delete their shares since those shares are redundant due to the system 100 being configured to allow only a maximum number of messages to be signed with the private key 112. Otherwise, at 516, processing continues with the signing HSM 104 generating the signature 144 or 228 using at least the private key 112, the message 132 or 210 and the state information 134 or 218.

At 518, the state information or counter is incremented by one and output, at 520, to the other HSMs 106/108, or another output is generated to propagate the updated indication of the highest number of times the private key 112 has been used to sign a message to a subset, or all, of the HSMs. At 522, the signature 144 or 226 is output for further processing and the private key 112 is deleted at 524 so that no more than one copy of the private key 112 exists at a time.

Although the flowchart 500 depicts performing operations in the order shown and described, examples are not limited to such an arrangement. For example, receiving the message at 502, receiving the shares at 504 and receiving the state information at 506, generating the private key at 508 and determining c_max, at 510, can be performed in any order that makes technical sense. Therefore, examples can be realised in which receiving the message at 502, receiving the shares at 504 and receiving the state information at 506, generating the private key at 508 and determining c_max are performed according to any and all permutations that make technical sense. Examples can be realised, for example, in which determining, at 510, the highest number of times the private key 112 has been used to sign a message, determining, at 512, if that highest number is less than the signing upper bound 130′, and instructing the HSMs to delete their respective shares at 514 are performed in advance of generating the private key 112 at 508 since there would be no point in generating the private key that private key cannot be used.

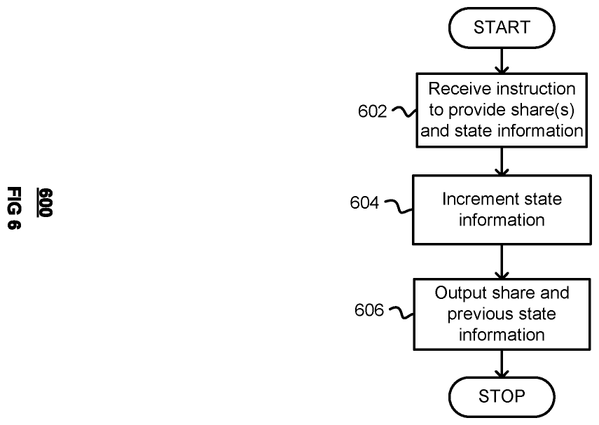

Referring to FIG. 6, there is shown a flowchart 600 of operations performed by a non-signing, but participating, HSM, referred to as a non-signing HSM, such as the above described HSMs 106 and 108. At 602, the non-signing HSM receives an instruction to send a respective share, or respective shares, and state information to a signing entity such as, for example, the signing HSM. As indicated above, the non-signing HSM increments, at 604, its respective state information, and outputs, at 606, the respective share or respective shares to the signing entity together with the state information as it was immediately prior to incrementing.

The functionality of the system 100, the dealer 102 and each HSM 104 to 108 can be realised in the form of machine instructions that can be processed by a machine comprising or having access to the instructions. The machine can comprise a computer, processor, processor core, DSP, a special purpose processor implementing the instructions such as, for example, an FPGA or an ASIC, circuitry or other logic, compiler, translator, interpreter or any other instruction processor. Processing the instructions can comprise interpreting, executing, converting, translating or otherwise giving effect to the instructions. The instructions can be stored on a machine readable medium, which is an example of machine-readable storage. The machine-readable medium can store the instructions in a non-volatile, non-transient, manner or in a volatile, transient, manner. The instructions can be arranged to give effect to any and all operations described herein taken jointly and severally in any and all permutations. The instructions can be arranged to give effect to any and all of the operations, devices, HSMs, dealers, systems, authenticators, flowcharts, protocols or methods described herein taken jointly and severally in any and all permutations. In particular, the machine instructions can give effect to, or otherwise implement, the operations of the flowcharts depicted in, or described with reference to, FIGS. 4, 5 and 6, taken jointly and severally in any and all permutations.

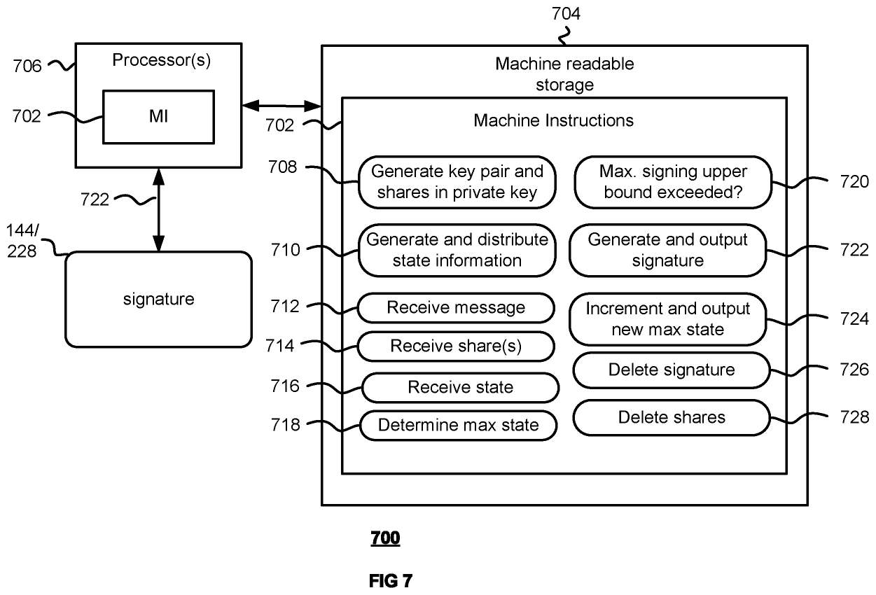

Therefore, FIG. 7 shows a view 700 of machine instructions 702 stored using machine readable storage 704 for implementing the examples described herein. The machine instructions 702 can be processed by, for example, a processor 706 or other processing entity, such as, for example, an interpreter, as indicated above.

The machine instructions 702 comprise at least one or more than one of:

Instructions 708 to generate the key pair 110 and to generate and distribute the shares 124 to 128 of the private key 112 of the key pair 110, as well as to distribute the public key 114 as described above,

Instructions 710 to generate and, where appropriate, distribute, the initial state information or counter values as described above,

Instructions 712 to receive a message to be signed,

Instructions 714 to receive shares of the private key 112 from participating HSMs, or from other participating HSMs, as described above,

Instructions 716 to receive state information or counter values from participating HSMs, or from other participating HSMs, as described above,

Instructions 718 to determine the highest number, c_max, 218 of messages that have been signed using the private key 112,

Instructions 720 to determine whether or not the signing upper bound 130′ has been exceeded as described above,

Instructions 722 to generate and output the signature using the private key 112, the message 132 and state information, subject to the signing upper bound 130′ as described above,

Instructions 724 to increment by one, or otherwise establish an update of, the state information or count representing the highest number of messaged that have been signed using the private key 112 as described above; the state information being established by either the signing HSM for distribution to any non-signing HSMs, or locally by the signing HSM and the non-signing HSMs.

Instructions 726 to delete the signature once it has been output or otherwise used, and

Instructions 728 to cause the HSM to delete their shares when those shares are redundant,

the foregoing instructions 708 to 728 being taken jointly and severally in any and all permutations.

Although the examples have been described with reference to the signing entity receiving shares and state information from a number of devices or from the same devices, examples are not limited thereto. To ensure that the signing entity has access to latest state information, state information should be received from the threshold, t>n/2, number devices. However, the threshold t number of shares can be obtained from fewer than t>n/2 devices if one or more such devices provide more than one respective share.

Examples can be realised according to the following clauses:

Clause 1: Machine-readable storage storing instructions arranged, when processed, to realise a cryptographic machine readable instructions for signing a message; the instructions comprising: instructions to receive, from a plurality of participating devices of a set of devices, a threshold number of shares of a private key, sk; the shares having been created using a (t,n)-threshold secret sharing scheme, where n>=t and t>n/2; instructions to receive respective state indicia from the plurality of participating devices; the respective state indicia being indicative of the number of messages having been signed using the private key, sk; instructions to recover the private key, sk, using the received shares; instructions to sign a message using a hash-based signature scheme subject to assessing a state indicium indicating the highest number of messages that have been signed using the private key, sk; and instructions to establish a state indicium indicating the highest number of messages, m, that have been signed using the private key, sk.

Clause 2: The machine-readable instructions of clause 1, comprising instructions to distribute the state indicium to at least a subset of the set of devices comprising more than n/2 device.

Clause 3: The machine-readable instructions of any preceding clause, in which the private key, sk, is a signature private key of a set of signature private keys associated with a private key.

Clause 4: The machine-readable instructions of any preceding clause, in which the private key, sk, is a one-time signature private key of a set of one-time signature private keys associated with a private key.

Clause 5: The machine-readable instructions of any preceding clause, in which the devices are hardware security modules.

Clause 6: The machine-readable instructions of any preceding clause, comprising instructions to generate the private key, sk, using a hash-based signature scheme parameter set associated with a hash-based signature scheme.

Clause 7: The machine-readable instructions of clause 6, in which the instructions to generate the private key, sk, using a hash-based signature scheme parameter set, associated with a hash-based signature scheme, comprise instructions to generating the private key, sk, using a hash-based signature scheme parameter set, associated with a hash-based signature scheme comprising a parameter, h, associated with the height of a tree associated with the hash-based signature scheme.

Clause 8: The machine-readable instructions of any preceding clause, comprising instructions to generate a state indicium in response to receiving a share of the private key, sk.

Clause 9: The machine-readable instructions of any preceding clause, comprising instructions to delete the recovered private key, sk, following signing the message.

Clause 10: The machine-readable instructions of any preceding clause, in which the instructions to establish the state indicium comprise instructions to increment a state indicium of the state indicia; the state indicium indicating the highest number of messages, m, that have been signed using the private key, sk; and instructions to distribute the incremented state indicium to at least a subset of the set of devices.

Clause 11: Machine-readable instructions to generate shares associated with a private key, sk, for signing a message, m; the machine-readable instructions comprising: instructions to generate n shares of the private key, sk, using a (t,n) threshold scheme, where t>n/2 is the threshold number of shares to recover the secret and n>=t; and instructions to distribute the shares to a set of devices.

Clause 12: The machine-readable instructions of clause 11, comprising instructions to generate the private key, sk, using a hash-based signature scheme parameter set associated with a hash-based signature scheme.

Clause 13: The machine-readable instructions of clause 12, in which the instructions to generate the private key, sk, using a hash-based signature scheme parameter set associated with a hash-based signature scheme comprise instructions to generate the private key, sk, using a hash-based signature scheme parameter set, associated with a hash-based signature scheme, comprising a parameter, h, associated with the height of a tree associated with the hash-based signature scheme.

Clause 14: The machine-readable instructions of any preceding clause, in which the (t,n) threshold scheme is a repairable threshold scheme; the machine-readable instructions comprising instructions to repair data associated with the (t,n) threshold sharing scheme of a device of the set of devices that has lost at least one, or both, of a respective state indicium and at least one respective share of the private key.

Clause 15: A cryptographic device for signing a message in a stateful hash-based signature system; the device comprising logic to: receive, from a plurality of participating devices of a set of devices, a threshold number of shares of a private key, sk; the shares having been created using a (t,n)-threshold secret sharing scheme, where n>=t and t>n/2; receive respective state indicia from the plurality of participating devices; the respective state indicia being indicative of the number of messages having been signed using the private key, sk; recover the private key, sk, using the received shares; sign a message using a hash-based signature scheme subject to assessing a state indicium indicating the highest number of messages that have been signed using the private key, sk; and establish a state indicium indicating the highest number of messages, m, that have been signed using the private key, sk.

Clause 16: A cryptographic method for signing a message; the method comprising receiving, from a plurality of participating devices of a set of devices, a threshold number of shares of a private key, sk; the shares having been created using a (t,n)-threshold secret sharing scheme, where n>=t and t>n/2; receiving respective state indicia from the plurality of participating devices; the respective state indicia being indicative of the number of messages having been signed using the private key, sk; recovering the private key, sk, using the received shares; signing a message using a hash-based signature scheme subject to assessing a state indicium indicating the highest number of messages that have been signed using the private key, sk; and establishing a state indicium indicating the highest number of messages, m, that have been signed using the private key, sk.

Clause 17: The method of clause 16, comprising distributing the state indicium to at least a subset of the set of devices comprising more than n/2 device.

Clause 18: The method of any of clauses 16 to 17, in which the private key, sk, is a signature private key of a set of signature private keys associated with a private key.

Clause 19: The method of any of clauses 16 to 18, in which the private key, sk, is a one-time signature private key of a set of one-time signature private keys associated with a private key.

Clause 20: The method of any of clauses 16 to 19, in which the devices are hardware security modules.

Clause 21: The method of any of clauses 16 to 20, comprising generating the private key, sk, using a hash-based signature scheme parameter set associated with a hash-based signature scheme.

Clause 22: The method of clause 21, in which generating the private key, sk, using a hash-based signature scheme parameter set, associated with a hash-based signature scheme, comprises generating the private key, sk, using a hash-based signature scheme parameter set, associated with a hash-based signature scheme comprising a parameter, h, associated with the height of a tree associated with the hash-based signature scheme.

Clause 23: The method of any of clauses 16 to 22, comprising generating a state indicium in response to receiving a share of the private key, sk.

Clause 24: The method of any of clauses 16 to 23, comprising deleting the recovered private key, sk, following signing the message.

Clause 25: The method of any of clauses 16 to 24, in which establishing the state indicium comprises incrementing a state indicium of the state indicia; the state indicium indicating the highest number of messages, m, that have been signed using the private key, sk; and distributing the incremented state indicium to at least a subset of the set of devices.

Clause 26: A method to generate shares associated with a private key, sk, for signing a message, m; the method comprising: generating n shares of the private key, sk, using a (t,n) threshold scheme, where t>n/2 is the threshold number of shares to recover the secret and n>=t; and distributing the shares to a set of devices.

Clause 27: The method of clause 26, comprising generating the private key, sk, using a hash-based signature scheme parameter set associated with a hash-based signature scheme.

Clause 28: The method of clause 27, in which generating the private key, sk, using a hash-based signature scheme parameter set associated with a hash-based signature scheme comprises generating the private key, sk, using a hash-based signature scheme parameter set, associated with a hash-based signature scheme, comprising a parameter, h, associated with the height of a tree associated with the hash-based signature scheme.

Clause 29: The method of any of clauses 26 to 28, in which the (t,n) threshold scheme is a repairable threshold scheme; the method comprising repairing data associated with the (t,n) threshold sharing scheme of a device of the set of devices that has lost at least one, or both, of a respective state indicium and at least one respective share of the private key.

Clause 30: A stateful hash-based signature system, the system comprising logic to implement a method of any of clauses 16 to 29.

Clause 31: A stateful hash-based signature system for signing a message; the system comprising logic to: receive, from a plurality of participating devices of a set of devices, a threshold number of shares of a private key, sk; the shares having been created using a (t,n)-threshold secret sharing scheme, where n>=t and t>n/2; receive respective state indicia from the plurality of participating devices; the respective state indicia being indicative of the number of messages having been signed using the private key, sk; recover the private key, sk, using the received shares; sign a message using a hash-based signature scheme subject to assessing a state indicium indicating the highest number of messages that have been signed using the private key, sk; and establishing a state indicium indicating the highest number of messages, m, that have been signed using the private key, sk.

1. Machine readable storage storing instructions arranged, when processed, to realise a cryptographic device for signing a message; the instructions comprising:
instructions to receive, from a plurality of participating devices of a set of devices, a threshold number of shares of a private key, sk; the shares having been created using a (t,n)-threshold secret sharing scheme, where n>=t and t>n/2;
instructions to receive respective state indicia from the plurality of participating devices; the respective state indicia being indicative of the number of messages having been signed using the private key, sk;
instructions to recover the private key, sk, using the received shares;
instructions to sign a message using a hash-based signature scheme subject to assessing a state indicium indicating the highest number of messages that have been signed using the private key, sk; and
instructions to establish a state indicium indicating the highest number of messages, m, that have been signed using the private key, sk.

2. The machine-readable instructions of claim 1, comprising instructions to distribute the state indicium to at least a subset of the set of devices comprising more than n/2 device.

3. The machine-readable instructions of claim 1, in which the private key, sk, is a signature private key of a set of signature private keys associated with a private key.

4. The machine-readable instructions of claim 1, in which the private key, sk, is a one-time signature private key of a set of one-time signature private keys associated with a private key.

5. The machine-readable instructions of claim 1, in which the devices are hardware security modules.

6. The machine-readable instructions of claim 1, comprising instructions to generate the private key, sk, using a hash-based signature scheme parameter set associated with a hash-based signature scheme.

7. The machine-readable instructions of claim 6, in which the instructions to generate the private key, sk, using a hash-based signature scheme parameter set, associated with a hash-based signature scheme, comprise instructions to generating the private key, sk, using a hash-based signature scheme parameter set, associated with a hash-based signature scheme comprising a parameter, h, associated with the height of a tree associated with the hash-based signature scheme.

8. The machine-readable instructions of claim 1, comprising instructions to generate a state indicium in response to receiving a share of the private key, sk.

9. The machine-readable instructions of claim 1, comprising instructions to delete the recovered private key, sk, following signing the message.

10. The machine-readable instructions of claim 1, in which the instructions to establish the state indicium comprise instructions to increment a state indicium of the state indicia; the state indicium indicating the highest number of messages, m, that have been signed using the private key, sk; and instructions to distribute the incremented state indicium to at least a subset of the set of devices.

11. Machine-readable instructions to generate shares associated with a private key, sk, for signing a message, m; the machine-readable instructions comprising:
instructions to generate n shares of the private key, sk, using a (t,n) threshold scheme, where t>n/2 is the threshold number of shares to recover the secret and n>=t; and
instructions to distribute the shares to a set of devices.

12. The machine-readable instructions of claim 11, comprising instructions to generate the private key, sk, using a hash-based signature scheme parameter set associated with a hash-based signature scheme.

13. The machine-readable instructions of claim 12, in which the instructions to generate the private key, sk, using a hash-based signature scheme parameter set associated with a hash-based signature scheme comprise instructions to generate the private key, sk, using a hash-based signature scheme parameter set, associated with a hash-based signature scheme, comprising a parameter, h, associated with the height of a tree associated with the hash-based signature scheme.

14. The machine-readable instructions of claim 11, in which the (t,n) threshold scheme is a repairable threshold scheme; the machine-readable instructions comprising instructions to repair data associated with the (t,n) threshold sharing scheme of a device of the set of devices that has lost at least one, or both, of a respective state indicium and at least one respective share of the private key.

15. A device for signing a message in a stateful hash-based signature system; the device comprising logic to:
receive, from a plurality of participating devices of a set of devices, a threshold number of shares of a private key, sk; the shares having been created using a (t,n)-threshold secret sharing scheme, where n>=t and t>n/2;
receive respective state indicia from the plurality of participating devices; the respective state indicia being indicative of the number of messages having been signed using the private key, sk;
recover the private key, sk, using the received shares;
sign a message using a hash-based signature scheme subject to assessing a state indicium indicating the highest number of messages that have been signed using the private key, sk; and
establish a state indicium indicating the highest number of messages, m, that have been signed using the private key, sk.
